(19) United States
(12) Patent Application Publication
(10) Pub. No.: US 2011/0234986 A1
(43) Pub. Date: Sep. 29, 2011

(54) MINIATURIZED PROJECTION IMAGE DISPLAY APPARATUS

(75) Inventor: So SUZUKI, Osaka (JP)

(73) Assignee: SANYO ELECTRIC CO., LTD., Osaka (JP)

(21) Appl. No.: 13/053,883

(22) Filed: Mar. 22, 2011

(30) Foreign Application Priority Data
Mar. 23, 2010 (JP) 2010-065770

(51) Int. Cl. G03B 21/30

(52) U.S. Cl. 353/43; 353/119

(57) ABSTRACT

A projection image display apparatus includes: a first casing which includes an image projection unit provided therein and a projection window provided at one end side thereof; and a second casing which has one end side coupled with the other end side of the first casing pivotably around a pivot axis. The first casing and the second casing are switchable between a first condition in which one side surface of the first casing and one side surface of the second casing are aligned opposite to each other and a second condition in which the first casing is pivoted from the first condition around the pivot axis within a plane orthogonal to the pivot axis and thus erected relative to the second casing.

This nonprovisional application is based on Japanese Patent Application No. 2010-065770 filed on Mar. 23, 2010, with the Japan Patent Office, the entire contents of which are hereby incorporated by reference.

### BACKGROUND OF THE INVENTION

1. Field of the Invention

The present invention relates to projection image display apparatuses and in particular miniaturized projection image display apparatuses projecting an image such that a top of a desk on which the projection image display apparatus is placed serves as a screen.

2. Description of the Related Art

Conventionally, projection image display apparatuses are generally placed on desks and project images on a wall surface serving as a screen. When this type of projection image display apparatus is used to project an image with its projection lens behind the top of the desk, the projected image is interrupted by the desk's top and cannot be entirely projected on the screen of the wall surface.

In view of this issue, a conventional projection image display apparatus has a casing formed to be longitudinally elongate and has an image projection lens at an upper portion of the casing. This projection image display apparatus thus configured allows an image projected through the projection lens to be projected on a screen of a wall surface entirely without being interpreted by the desk's top present before the projection lens.

The above conventional projection image display apparatus that has a longitudinally elongate casing and a projection lens positioned at an upper portion of the casing, however, results in the casing having its center of gravity at an upper portion thereof. Furthermore, with the longitudinally elongate casing, the projection image display apparatus is placed in contact with a reduced area. As a result, the projection image display apparatus will be placed significantly unstably.

Furthermore, a projection image display apparatus that is placed on a desk and projects an image on the desk's top also needs to have an image projection unit at an upper portion of the casing to obtain a large image projection area. Accordingly, the projection image display apparatus will also be longitudinally elongate and invite a similar issue.

### SUMMARY OF THE INVENTION

The present invention in one aspect provides a projection image display apparatus including: a first casing which includes an image projection unit provided therein and a projection window provided at one end side thereof; and a second casing which has one end side coupled with the other end side of the first casing pivotably around a pivot axis. The first casing and the second casing are switchable between a first condition in which one side surface of the first casing and one side surface of the second casing are aligned opposite to each other and a second condition in which the first casing is pivoted from the first condition around the pivot axis within a plane orthogonal to the pivot axis and thus erected relative to the second casing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external perspective view of a projection image display apparatus according to the present embodiment in use as seen at a side thereof having a projection window.

FIG. 2 is an external perspective view of the projection image display apparatus according to the present embodiment in use as seen at a side thereof having a connection terminal connected to external equipment.

FIG. 3 is a perspective view of the projection image display apparatus according to the present embodiment, with external equipment connected thereto.

FIG. 4 is a side view of the projection image display apparatus according to the present embodiment, showing a range in which its projector unit pivots.

FIG. 5 is an external perspective view of the projection image display apparatus according to the present embodiment, as seen when it is not used.

FIG. 6 shows how the projector unit is internally configured according to the present embodiment, as seen through in a front view.

FIG. 7 shows how the projector unit is internally configured according to the present embodiment, as seen through in a side view.

FIG. 8 is a flowchart of a flow of control with a sensor according to the present embodiment.

FIG. 9 is a perspective view of an image projected from the projection image display apparatus according to the present embodiment that is picked up by an image pickup device.

### DESCRIPTION OF THE PREFERRED EMBODIMENTS

Hereinafter reference will be made to the drawings to describe the present invention in an embodiment. In the figures, identical or corresponding components are identically denoted and will not be described repeatedly in detail.

It should be noted that the figures are schematic and that each dimension's ratio and the like are different from those in reality. Accordingly any specific dimension and the like should be determined with the following description taken into consideration. Furthermore, it is also a matter of course that the figures include mutually different dimensional relationships, ratios and/or the like.

### Summary of Embodiment

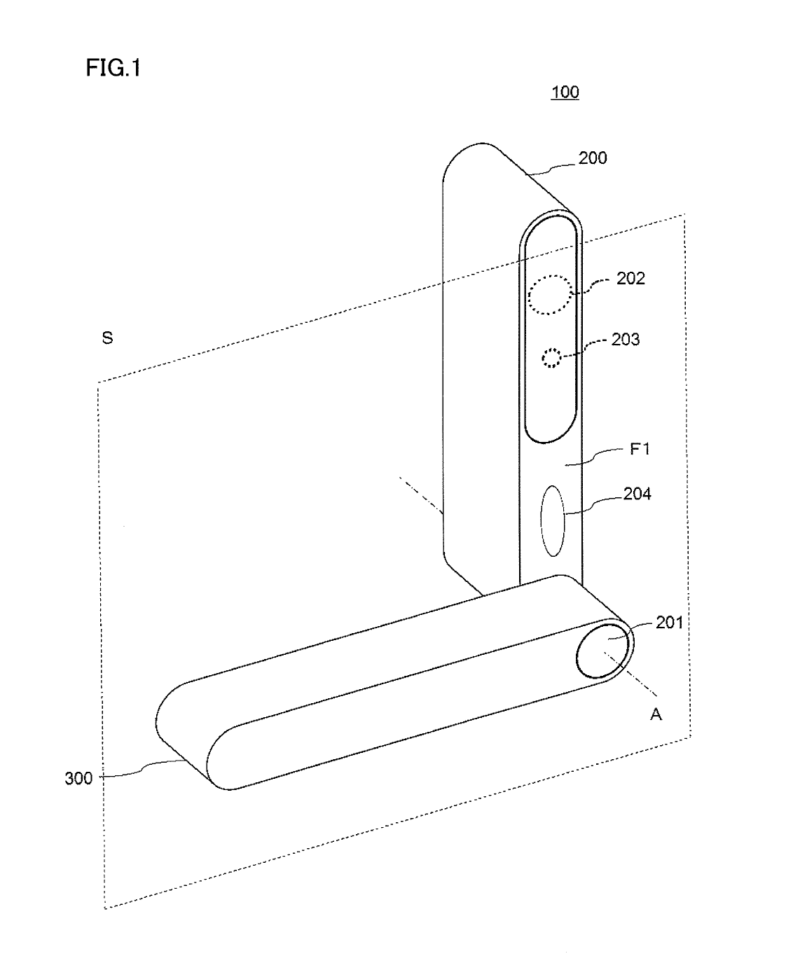

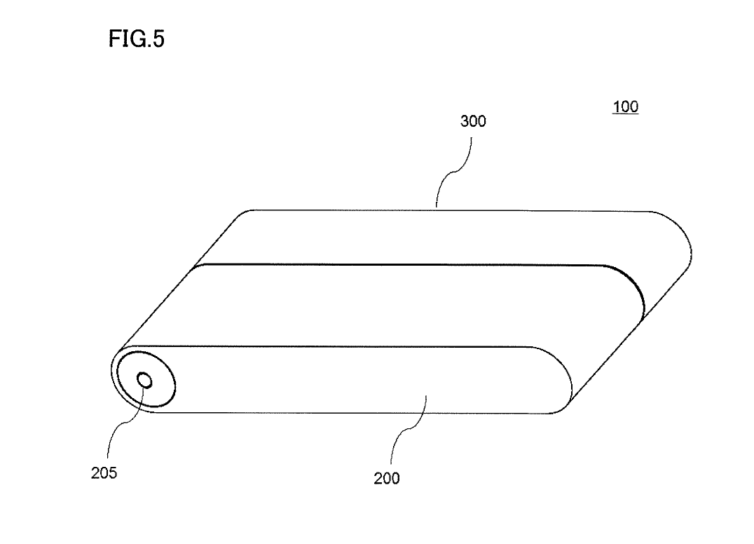

The present embodiment provides a projection image display apparatus including a first casing (or a projector unit 200) internally provided with an image projection unit and having one end side provided with a projection window, and a second casing (or a battery unit 300) having one end side coupled with the other end side of the first casing pivotably as desired around a pivot axis A. Projector unit 200 and battery unit 300 are switchable between a first condition in which projector unit 200 and battery unit 300 have one side surface F1 and one side surface F2, respectively, aligned opposite to each other (i.e., a condition shown in FIG. 5), and a second condition in which projector unit 200 is pivoted relative to battery unit 300 from the first condition around pivot axis A within a pivot plane S orthogonal to pivot axis A and is thus erected (i.e., a condition shown in FIG. 1).

Thus when the projection image display apparatus is used with projector unit 200 pivoted and thus erected battery unit 300 can be in contact with a placement surface (or a top of a desk if the projection image display apparatus is placed on the desk), and the projection image display apparatus can thus be placed stably.

### Present Embodiment

Configuration of Projection Image Display Apparatus

The present embodiment provides a projection image display apparatus configured as will be described hereinafter with reference to the drawings.

FIG. 1 is an external perspective view of a projection image display apparatus according to the present embodiment in use as seen at a side thereof having a projection window.

With reference to FIG. 1, a projection image display apparatus 100 is configured of projector unit 200 and battery unit 300. Projector unit 200 and battery unit 300 are each provided in the form of a flat rectangular parallelepiped having opposite ends curved. Projector unit 200 and battery unit 300 have their respective one ends electrically and mechanically coupled together to be pivotable, as desired, relative to each other around pivot axis A. At the opposite ends of pivot axis A is provided a thin disk member 201. Projector unit 200 and battery unit 300 pivot relative to each other along pivot plane S orthogonal to pivot axis A. Projector unit 200 and battery unit 300 have a longitudinal dimension along pivot axis A, a lateral dimension, which corresponds to the flat rectangular parallelepiped's longest side, and a height, which corresponds to the flat rectangular parallelepiped's thickness. Projector unit 200 and battery unit 300 are equal in lateral dimension and height and the former is larger than latter in longitudinal dimension.

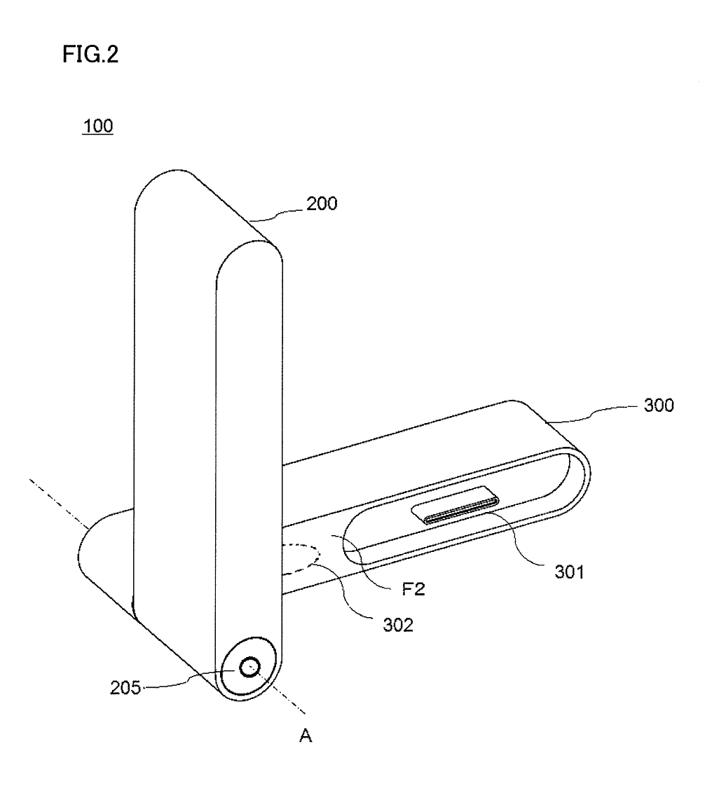

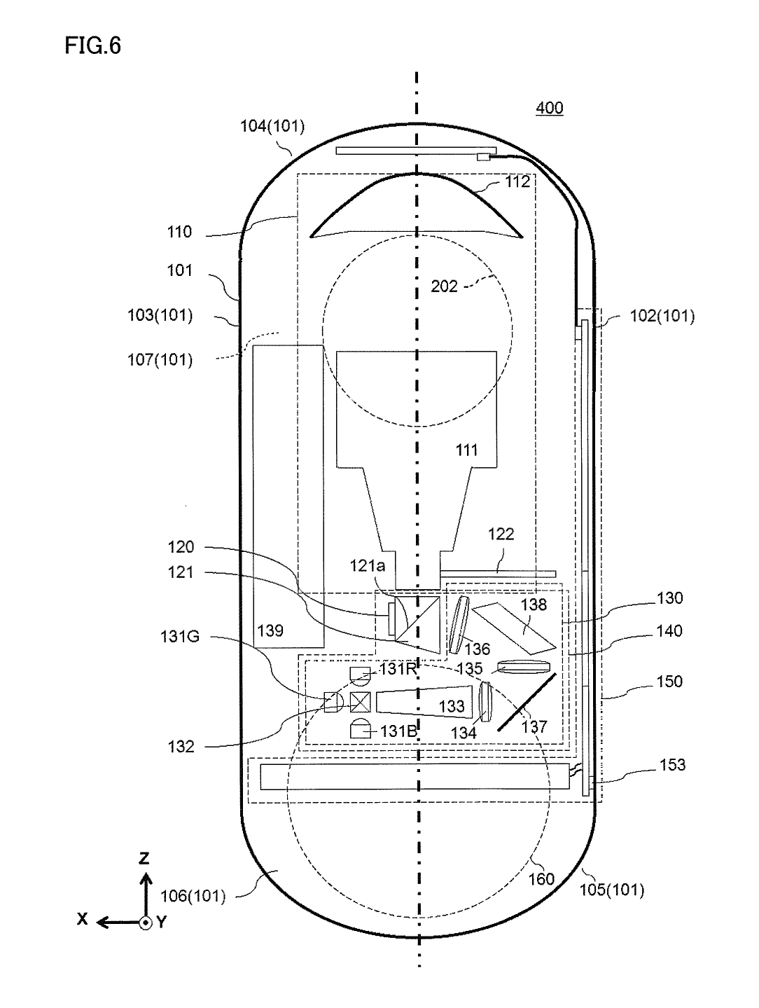

Projector unit 200 includes a projection window 202, a sensor 203, a first remote controller light receiving unit 204, and a power supply terminal 205 (see FIG. 2). Projector unit 200 further includes an image projection unit 400 therein (see FIG. 6).

Projection window 202 is configured of a transparent member and provided at one end side of projector unit 200. Projection window 202 has a transparent region having an area sufficient to avoid interrupting an image's light generated in image projection unit 400.

Sensor 203 is provided in a vicinity of projection window 202 and closer to the center of projector unit 200 than projection window 202 is. Sensor 203 is for example a complementary metal oxide semiconductor (CMOS) sensor. Sensor 203 picks up an image region projected through projection window 202 to a projection plane. Accordingly, the CMOS sensor is attached to projector unit 200 so as to be able to pick up image slightly below.

First remote controller light receiving unit 204 is provided to projector unit 200 at a position close to pivot axis A. First remote controller light receiving unit 204 is a photoreceptive unit receiving an infrared signal generated by operating an operation button of an accessory remote controller (not shown).

Reference will now be made to FIG. 2 to describe how projection image display apparatus 100 is configured. FIG. 2 is an external perspective view of the projection image display apparatus according to the present embodiment in use as seen at a side thereof having a connection terminal connected to external equipment.

With reference to FIG. 2; projector unit 200 includes power supply terminal 205 on pivot axis A. Power supply terminal 205 is exposed when thin disk member 201 (not shown) attached to projector unit 200 is removed. When projection image display apparatus 100 is carried, thin disk member 201 protects power supply terminal 205.

Power supply terminal 205 is connected to a power supply cord provided on pivot axis A as an accessory of projection image display apparatus 100. The power supply cord (not shown) connected to power supply terminal 205 supplies projector unit 200 and battery unit 300 with electric power.

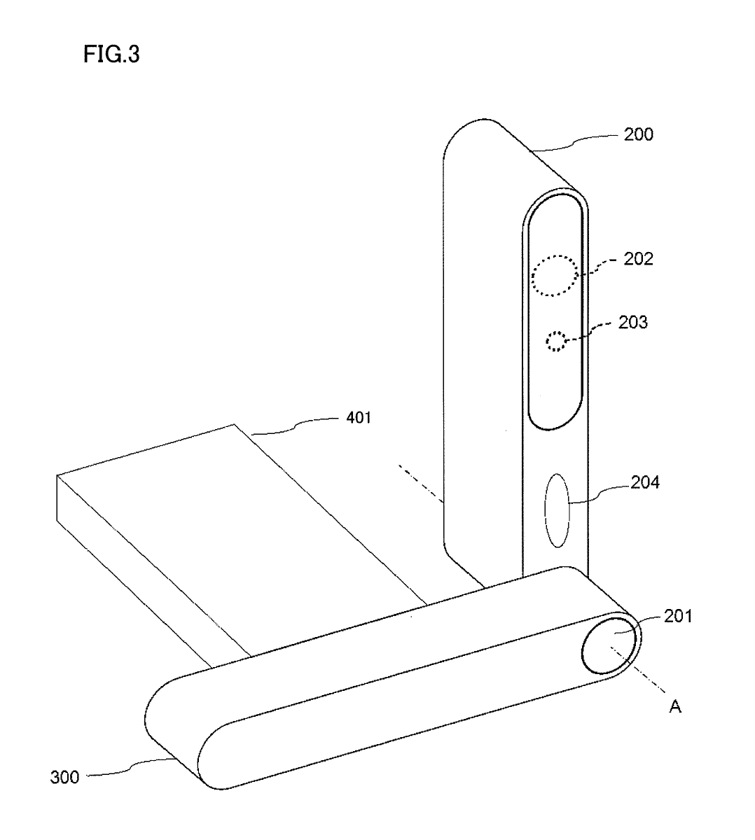

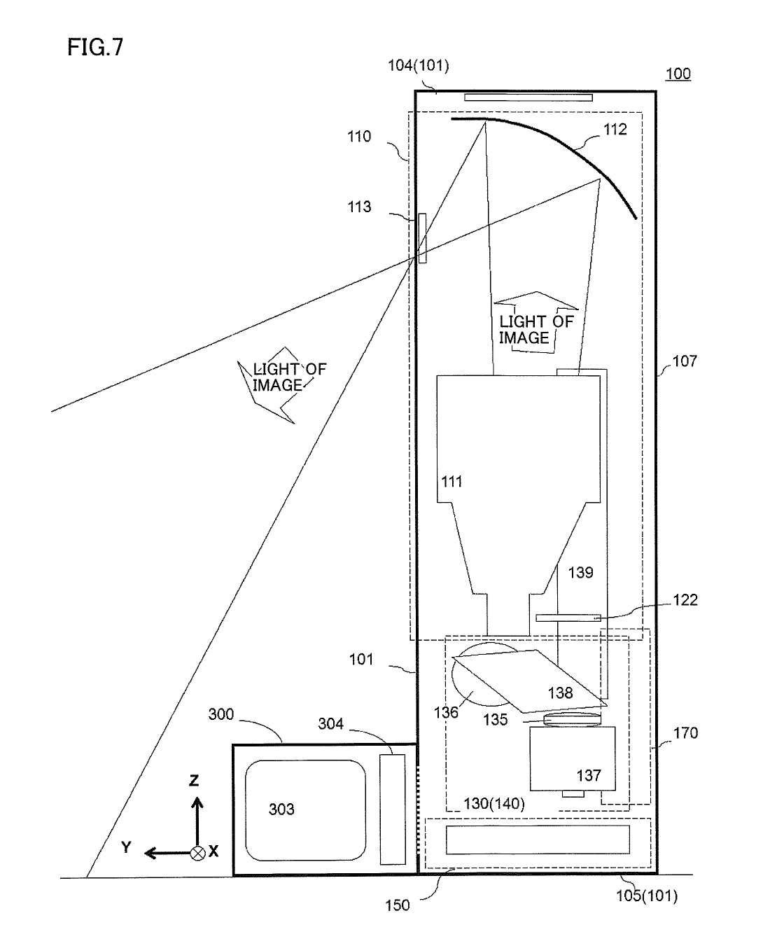

Battery unit 300 includes a connection terminal 301 for connection to external equipment 401 (see FIG. 3), and a second remote controller light receiving unit 302. Battery unit 300 further includes therein a battery 303 (see FIG. 7) feeding electric power to projector unit 200 and external equipment 401 (see FIG. 3) connected to connection terminal 301.

Connection terminal 301 is provided at one side of battery unit 300. Connection terminal 301 has a terminal corresponding to a connection terminal of external equipment 401. Connecting external equipment 401 to connection terminal 301 allows an image that external equipment 401 outputs to be received by projection image display apparatus 100 as an input signal.

Second remote controller light receiving unit 302 is provided to battery unit 300 at a position close to pivot axis A. Second remote controller light receiving unit 302 in the FIG. 5 position is opposite to first remote controller light receiving unit 204. Second remote controller light receiving unit 302 is a photoreceptive unit receiving an infrared signal generated by operating an operation button of an accessory remote controller (not shown).

FIG. 3 is a perspective view of the projection image display apparatus according to the present embodiment, with external equipment connected thereto.

With reference to FIG. 3, battery unit 300 has connection terminal 301 in the form of a male terminal and external equipment 401 has a female terminal (not shown). Battery unit 300 and external equipment 401 are electrically connected together via the terminals. When battery unit 300 has external equipment 401 connected thereto, external equipment 401 and battery unit 300 are placed on a placement surface such that they are flush with each other. Thus when external equipment is connected, the projection image display apparatus is placed significant stably. Consequently, the projection image display apparatus does not wobble or the like while the external equipment is operated.

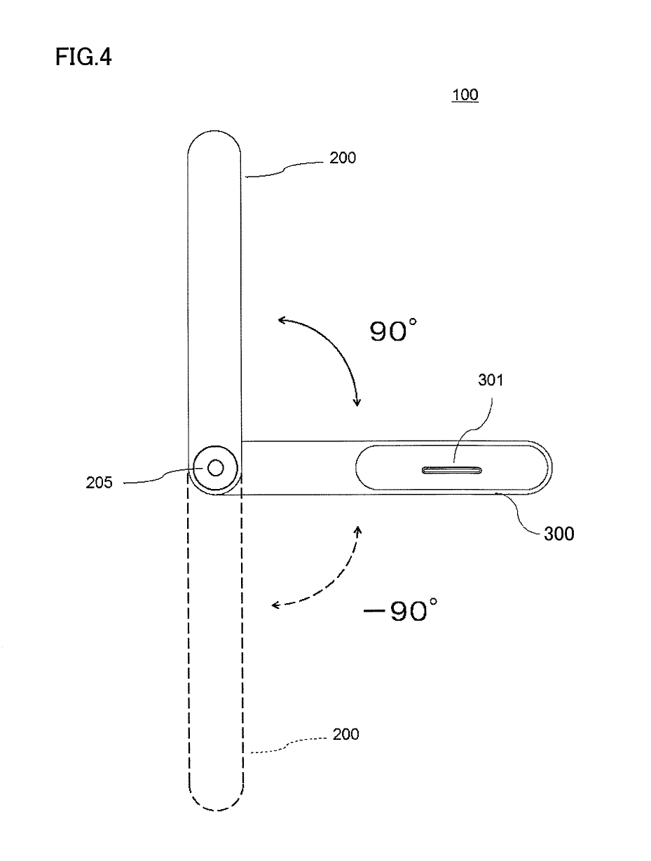

FIG. 4 is a side view of the projection image display apparatus according to the present embodiment, showing a range in which the projection image display apparatus pivots.

With reference to FIG. 4, projection image display apparatus 100 allows projector unit 200 to be pivoted from an unused position (see FIG. 5) by 90° in a positive direction and 90° in a negative direction. Projection image display apparatus 100 has a mechanism (not shown) providing a feeling of clicking when projector unit 200 is pivoted. This mechanism also functions as a mechanism serving a stopper at an end of pivoting. This can facilitate holding projector unit 200 at a position of 90° in the positive direction or that of 90° in the negative direction.

FIG. 5 is an external perspective view of the projection image display apparatus according to the present embodiment, as seen when it is not used.

With reference to FIG. 5, when projection image display apparatus 100 is not used, a surface of projector unit 200 having projection window 202, sensor 203 and first remote controller light receiving unit 204 and that of battery unit 300 having connection terminal 301 and second remote controller light receiving unit 302 face each other. In causing the surfaces to face each other when the FIG. 5 position is assumed the mechanism providing a feeling of clicking (not shown) operates to provide a feeling of clicking to hold projector unit 200 and battery unit 300 flush with and opposite to each other. Projection image display apparatus 100 can thus be carried with the projector unit 200 projection window 202, sensor 203 and first remote controller light receiving unit 204 and the battery unit 300 connection terminal 301 and second remote controller light receiving unit 302 hidden.

While projector unit 200 and battery unit 300 are provided at the opposite ends of pivot axis A with thin disk member 201, they are not limited thereto, and projector unit 200 may not have thin disk member 201 and may have power supply terminal 205 exposed. Alternatively, battery unit 300 may have thin disk member 201 replaced with a printed or recessed/projected marking or the like.

Furthermore, while sensor 203 is provided in a vicinity of projection window 202 and closer to the center of the projector unit than projection window 202 is, it is not limited thereto and sensor 203 may be provided closer to an end than projection window 202 is.

Function and Effect

When it is necessary to provide image projection unit 400 at an upper portion of a casing, projection image display apparatus 100 can nonetheless be placed stably.

When power supply terminal 205 is provided to projector unit 200 on pivot axis A and power supply terminal 205 has connected thereto a power supply cord (not shown) provided as an accessory of projection image display apparatus 100, the power supply cord is drawn out in a direction different from that in which an image is projected, and the image can be projected without interruption.

Furthermore, when projection image display apparatus 100 is used (see the FIGS. 2 and 4 positions), the power supply cord (not shown) is connected to a lower portion of projection image display apparatus 100, and the user is thus prevented from erroneously pulling the power supply cord (not shown).

Furthermore, even when projection image display apparatus 100 is not used (see the FIG. 5 position), the power supply cord (not shown) can be connected, and battery 303 can thus be charged.

Thin disk member 201 provided at the opposite ends of pivot axis A can help the user to know which one end has pivot axis A. When using projection image display apparatus 100, the user can easily recognize which one end has the pivot axis, and the user can thus pivot projector unit 200 more easily.

When projection image display apparatus 100 is not used, a surface of projector unit 200 having projection window 202, sensor 203 and first remote controller light receiving unit 204 and that of battery unit 300 having connection terminal 301 and second remote controller light receiving unit 302 can face each other, and projection image display apparatus 100 thus does not have a recess or a projection and can thus be accommodated compactly.

Furthermore, projection image display apparatus 100 that can be carried with the projector unit 200 projection window 202, sensor 203 and first remote controller light receiving unit 204 and the battery unit 300 connection terminal 301 and second remote controller light receiving unit 302 hidden, can prevent each component from being damaged, soiled and/or the like and also prevent dust from depositing thereon.

With second remote controller light receiving unit 302 provided opposite to first remote controller light receiving unit 204, projection image display apparatus 100 can be operated via a remote controller at a front side of projection image display apparatus 100 and a rear side of projection image display apparatus 100.

Sensor 203 provided at an end of projector unit 200 has an increased distance to a projection plane and can thus pick up the projection plane over a large area.

Projection image display apparatus 100 that allows projector unit 200 to be pivoted from the unused position (the FIG. 5 position) by 90° in the positive direction and 90° in the negative direction, can project an image with projector unit 200 erected perpendicular to the placement surface to provide an increased distance from projection window 202 to the projection plane, and thus allows the projected image to have a large area. Furthermore, when projection image display apparatus 100 is placed at a location having an obstacle against battery unit 300, battery unit 300 can be pivoted by 180° to avoid the obstacle.

Battery unit 300 in the form of a flat rectangular parallelepiped allows projection image display apparatus 100 to be used such that it is placed over a large area, and projection image display apparatus 100 can thus be placed on a placement surface stably.

Configuration of Image Projection Unit

Projector unit 200 has image projection unit 400, as will be described hereinafter more specifically with reference to FIG. 6.

FIG. 6 shows how the projector unit is internally configured according to the present embodiment, as seen through in a front view.

With reference to FIG. 6, projector unit 200 includes: a projection unit 110 configured of a projection lens group 111 and an aspheric mirror 112; a digital micromirror device (DMD) 120 serving as a photomodulation device; an illumination unit 130 exposing DMD 120 to light; a DMD control circuit 122; an LED control circuit 139; and a main control circuit 150.

In the present embodiment, a surface (a horizontal surface) on which projection image display apparatus 100 is placed is represented as an x-y plane and a direction perpendicular to the placement surface (i.e., a vertical direction) is defined as the direction of a z axis. An x axis extends in a direction corresponding to a widthwise direction of casing 101 of projector unit 200 and a y axis extends in a direction corresponding to a depthwise direction of casing 101.

Casing 101 in FIG. 6 has a right side surface or one side surface 102, a left side surface or the other side surface 103, an upper surface or a top surface 104, and a lower surface or a bottom surface 105. Furthermore, casing 101 has a front surface 106 serving as a surface of a side emanating an image's light in FIG. 1, and a rear surface 107 opposite to front surface 106.

While casing 101 is a flat rectangular parallelepiped with top surface 104 and bottom surface 105 curved, it is not limited thereto. It may be a generally rectangular parallelepiped with the six surfaces all flat. It should be noted therefore that in the present invention when a “surface” is referred to it includes a flat surface and a curved surface.

Projection unit 110 includes projection lens group 111 configured of a plurality of lenses, aspheric mirror 112 configured of a concave aspheric mirror, and projection window 202 emanating an image's light. Projection lens group 111 emanates along the z axis an image's light modulated at DMD 120. Aspheric mirror 112 is provided over projection lens group 111 and receives the image's light from projection lens group 111 and reflects it obliquely downward. Aspheric mirror 112, which is a concave mirror, condenses the image's light and then enlarges and thus projects the image's light. Projection window 202 is provided in a vicinity of a location at which the image's light is condensed. The image's light forms an image between projection lens group 111 and aspheric mirror 112 and again forms an image on a surface on which projection image display apparatus 100 is placed (i.e., the x-y plane in the figure)

DMD 120 operates in response to an image input signal to modulate blue, green and red illumination lights that illumination unit 130 emits in a time division manner. DMD 120 is provided integral to a prism block 121 guiding the image's light to projection lens group 111. Prism block 121 has a surface 121a receiving illumination light from illumination unit 130 and transmitting it, and also totally reflecting the image's light that has been modulated at DMD 120, and guiding the image's light to projection lens group 111. In a vicinity of DMD 120 is provided DMD control circuit 122 controlling DMD 120. DMD control circuit 122 controls DMD 120 in response to an image input signal and an LED control signal.

Illumination unit 130 has LEDs 131R, 131G, 131B emanating red, green and blue lights, and a plurality of optical members compositing and thus outputting red, green and blue lights to DMD 120. In the present embodiment, the optical member compositing red, green and blue lights is provided in the form of a dichroic prism 132. Dichroic prism 132 provides composite light, which in turn has its quantity of light distributed uniformly by a taper rod 133. Downstream of taper rod 133 are lenses 134, 135, 136 having a function to receive light from taper rod 133 and collimate the light, and also form an image of the collimated light on DMD 120. Mirrors 137, 138 have a function to bend the composite light's optical path in conformity to the casing's space.

In a vicinity of LED 131 is provided LED control circuit 139 controlling LED 131. LED control circuit 139 operates in response to an image input signal to control in what quantity and when LEDs 131R, 131G, 131B should emit light. Furthermore, LED control circuit 139 transmits to DMD control circuit 122 an LED control signal associated with in what quantity and when the LEDs should emit light. Desirably, LED control circuit 139 is provided in a vicinity of LED 131 to reduce a connection line in length. On the other hand, with an electromagnetic wave's effect considered, positioning LED control circuit 139 as remotely from DMD control circuit 122 as possible is also desired. DMD 120 and illumination unit 130 will collectively be referred to as an image light generation unit 140.

Main control circuit 150 is electrically connected to battery unit 300 via power supply terminal 205 and a communicating pivot hole 160. Main control circuit 150 receives electric power supplied through the power supply terminal or from battery unit 300 and controls electric power supplied to image light generation unit 140 (LED 131, DMD 120 and the like in particular). Furthermore, main control circuit 150 transmits a control signal to DMD control circuit 122 and LED control circuit 139 in response to an image input signal received via connection terminal 301 or the like.

Although not shown in FIG. 6, front surface 106 is provided with sensor 203 and first remote controller light receiving unit 204, as shown in FIG. 1. Main control circuit 150 obtains a result of picking up an image within a projected image that is provided from sensor 203, and main control circuit 150 subjects the result to an image analysis to determine whether there is a trespassing object. Main control circuit 150 obtains a result of receiving an infrared signal from first remote controller light receiving unit 204 and thus adjusts a variety of settings of projection image display apparatus 100, and also controls a projected image.

Main control circuit 150 further includes a non-volatile memory 153 capable of storing data. Non-volatile memory 153 stores data received from external equipment 401. Projection image display apparatus 100 can thus alone project as an image the data stored in non-volatile memory 153.

Configuration of Battery Unit

Projector unit 200 has image projection unit 400, as will be described hereinafter more specifically with reference to FIG. 7.

FIG. 7 shows how the projector unit is internally configured according to the present embodiment, as seen through in a side view.

With reference to FIG. 7, battery unit 300 includes battery 303 configured of a nickel hydrogen secondary battery, and a battery control circuit 304 controlling charging/discharging battery 303. Battery 303 has a dimension along the x axis that is sufficiently longer than those along the y and z axes, respectively. Battery control circuit 304 controls electric power supplied from a commercial power supply via a power supply cord (not shown) and power supply terminal 205 to battery 303, and controls electric power supplied from battery 303 to image light generation unit 140 (LED 131 and DMD 120 in particular). When battery unit 300 is not connected to the commercial power supply and external equipment 401 is connected via connection terminal 301, battery control circuit 304 can supply the electric power that is stored in battery 303 to external equipment 401 to charge external equipment 401. On the other hand, when battery unit 300 is connected to the commercial power supply and external equipment 401 is connected via connection terminal 301, battery control circuit 304 can supply the electric power that is received from the commercial power supply to external equipment 401 to charge external equipment 401. Battery 303 may not be the nickel hydrogen secondary battery; it may be a lithium ion secondary battery or a capacitor.

Function and Effect

As main control circuit 150 includes non-volatile memory 153 capable of storing data, it is not necessary to constantly connect to external equipment 401 to project an image, and projection image display apparatus 100 of the present invention can alone be used to project an image.

When battery unit 300 is not connected to a commercial power supply and external equipment 401 is connected via connection terminal 301, battery control circuit 304 can supply the electric power that is stored in battery 303 to external equipment 401 to charge external equipment 401. In other words, battery control circuit 304 can function as an auxiliary battery for external equipment 401. Furthermore, when battery unit 300 is connected to the commercial power supply and external equipment 401 is connected via connection terminal 301, battery control circuit 304 can supply the electric power that is received from the commercial power supply to external equipment 401 to charge external equipment 401. In other words, projection image display apparatus 100 can function as a cradle for external equipment 401.

Control Flow by Sensor

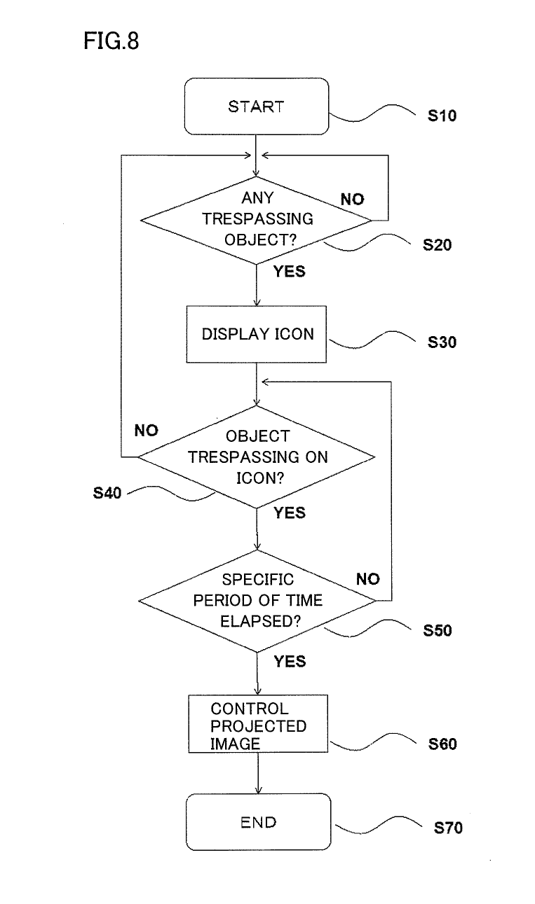

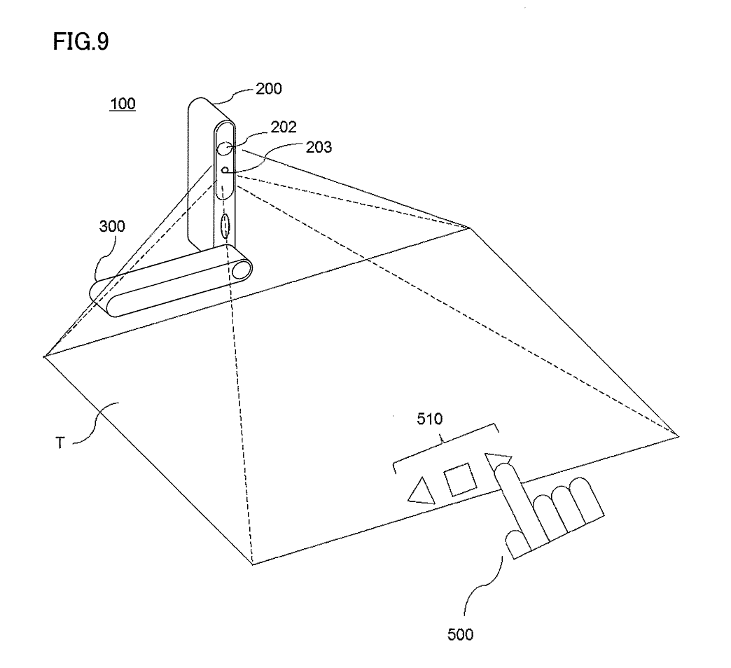

Sensor 203 is used in controlling a projected image in a method, as will be described hereinafter more specifically with reference to FIG. 8 and FIG. 9.

FIG. 8 is a flowchart of a flow of control with a sensor according to the present embodiment. FIG. 9 is a perspective view of an image projected from the projection image display apparatus according to the present embodiment that is picked up by an image pickup device.

With reference to FIG. 9, projection image display apparatus 100 projects an image through projection window 202 such that a surface T on which projection image display apparatus 100 is placed serves as a projection plane, and projection image display apparatus 100 also picks up an image within the projected image's area with sensor 203. Note that when the projection image display apparatus is placed on a desk, the desk's top will be placement surface T.

With reference again to FIG. 8, a control flow for sensor 203 will be described hereinafter. Projection image display apparatus 100 projects an image on placement surface T, and in that condition, sensor 203 picks up the projected image (step 10). From the image picked up, sensor 203 senses whether the user's hand 500 trespasses on the projected image's area (step 20). If not (NO at step 20), sensor 203 determines that the user has no intention to control the projected image, and sensor 203 continues to pick up an image until the user's hand 500 trespasses on the image.

If the user's hand 500 trespasses on the image (YES at step 20), sensor 203 determines that there is a possibility that the user may control the projected image, and an icon 510 is superposed within the projected image and thus indicated on screen display (or OSDed) (step 30).

After the user's hand 500 has trespassed on the projected image, sensor 203 still continues to pick up image within the projected image, and from the image picked up, sensor 203 senses whether the user's hand 500 overlaps any of icons 510 (step 40). If not (NO at step 40), it is determined that the user has no intention to control the projected image and that the user currently uses the projected image to for example provide a presentation or the like. Sensor 203 maintains an OSD indication of icon 510 and thus returns to step 20.

When the user's hand 500 overlaps any of icons 510 (YES at step 40), sensor 203 senses whether the user's hand 500 continues to overlap icon 510 for a specific period of time (for example of one second) (step 50). If not (NO at step 50), it is determined that the user's hand 500 only temporarily overlaps the icon, and the control returns to step 40.

If the user's hand 500 continues to overlap icon 510 for the specific period of time (YES at step 50), then, depending on the type of icon 510 overlapped, a variety of types of settings of projection image display apparatus 100 can be operated and the image can be frame-advanced/receded and fast-forwarded/rewound.

Function and Effect

Thus it is no longer necessary that the user directly touches the projection image display apparatus to operate an operation button and/or uses a remote controller to perform an operation: the user can directly touch a projected image to do a variety of types of settings of the projection image display apparatus, control the projected image and the like, and the user can thus perform an intuitive operation.

### Other Embodiment

While the present invention has been described by the above embodiment, it should be understood that the present invention is not limited by any discussion or figure constituting a portion of the present disclosure. From the present disclosure, a variety of alternative embodiments, examples and techniques for operation will be apparent to those skilled in the art.

More specifically, while the light source has been described as an LED, it is not limited thereto. When the light source is a solid light source, it may be a laser light source, and when it is a lamp light source, it may be a high-pressure mercury-vapor lamp, a xenon lamp or the like. The laser light source can be reflected by a vertically movable mirror and a horizontally movable mirror to draw an image on a projection plane, i.e., a light source of a so called scanning system can also be used. The optical modulation device has been described as a DMD, it may be a transmission, semi-transmission or reflection liquid crystal panel or the like.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection image display apparatus comprising:
a first casing which includes an image projection unit provided therein and a projection window provided at one end side thereof; and
a second casing which has one end side coupled with the other end side of said first casing pivotably around a pivot axis, said first casing and said second casing being switchable between a first condition in which one side surface of said first casing and one side surface of said second casing are aligned opposite to each other and a second condition in which said first casing is pivoted from said first condition around said pivot axis within a plane orthogonal to said pivot axis and thus erected relative to said second casing.

2. The projection image display apparatus according to claim 1, wherein:
said first casing is held in said second condition such that said first casing is pivoted from said first condition by approximately 90 degrees relative to said second casing and thus erected to project on a placement surface an image's light emitted through said projection window; and
said second casing is placed on said placement surface in said second condition.

3. The projection image display apparatus according to claim 1, wherein a power feeding battery is provided internal to said second casing.

4. The projection image display apparatus according to claim 1, wherein said projection window is provided at said one side surface of said first casing.

5. The projection image display apparatus according to claim 1, wherein said second casing is provided at said one side surface thereof with a connection terminal for connecting said second casing and external equipment together.

6. The projection image display apparatus according to claim 1, wherein said first casing and said second casing are each a flat rectangular parallelepiped.

7. The projection image display apparatus according to claim 1, wherein at least one of said first casing and said second casing includes a storage unit capable of storing data; and
said first casing projects from said image projection unit onto a projection plane an image corresponding to the data stored in said storage unit.

8. The projection image display apparatus according to claim 1, further comprising a detection unit which detects a position of an object trespassing on an image projected on a projection plane, wherein said image projection unit is operative in response to a result of detection by said detection unit to control the image projected on said projection plane.

9. A projection image display apparatus comprising:
a first casing which includes an image projection unit provided therein and a projection window provided at one end side thereof, and a second casing which has one end side coupled with the other end side of said first casing pivotably around a pivot axis, said first casing and said second casing being switchable between a first condition in which one side surface of said first casing and one side surface of said second casing are aligned opposite to each other and a second condition in which said first casing is pivoted from said first condition around said pivot axis within a plane orthogonal to said pivot axis and thus erected relative to said second casing;
a power feeding battery; and
a connection terminal which connects the projection image display apparatus and external equipment together, at least said battery feeding said external equipment with electric power when said external equipment is connected to said connection terminal.
